(19) United States
(12) Patent Application Publication
(10) Pub. No.: US 2025/0074490 A1
(43) Pub. Date: Mar. 6, 2025

(54) MANUAL OPERATED SWING ARM DOLLY

(71) Applicant: Toyota Motor Engineering & Manufacturing North America, Inc., Plano, TX (US)

(72) Inventors: Kenneth E. Roy, Walton, KY (US); John P. Ferguson, Mitchell, IN (US); Scottie L. Foster, Lawrenceburg, KY (US); Bradley J. Garcia, Louisville, KY (US); Jeffrey L. James, Mount Sterling, KY (US); Michael C. Greenlee, Paris, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/458,943

(22) Filed: Aug. 30, 2023

(51) Int. Cl. B62B 3/04; B62B 5/00

(52) U.S. Cl. CPC B62B 3/04; B62B 5/0089; B62B 2202/10

(57) ABSTRACT

Systems and methods are provided for a swing arm dolly. A swing arm dolly can comprise a swing arm mounted on a frame. A lever and locking mechanism can lock the swing arm to the frame. One or more wheels can extend downward from the swing arm. The swing arm dolly can also comprise a spring-loaded plunger secured to the frame, wherein upon disengaging the locking mechanism, the one or more wheels roll onto the spring-loaded plunger, pushing the spring-loaded plunger downward to lock the swing arm dolly.

### TECHNICAL FIELD

The present disclosure relates generally to mobile carts/dollies, and in particular, some implementations may relate to the operation of mobile carts/dollies through a swing arm.

### DESCRIPTION OF RELATED ART

Mobile carts and dollies can be used to transport various items. Traditional mobile carts and dollies can include a shelf or platform mounted on wheels. Items can be placed on the shelf or platform, and the shelf or platform can be transported by pushing or pulling the dolly on the wheels. Mobile carts and dollies can move freely based on the wheels, casters, or other motive elements. Some dollies incorporate swing arms, which allow a platform, operatively connected to such swing arms, to rotate along an axis at the end of the platform, with the swing arm reaching out and away from the dolly. Incorporating a swing arm can allow users to reach items on the dolly as they step further away from the dolly.

### BRIEF SUMMARY OF THE DISCLOSURE

According to various embodiments of the disclosed technology, a swing arm dolly can comprise a swing arm mounted on a frame; a lever and locking mechanism locking the swing arm to the frame; one or more wheels extending downward from the swing arm; and a spring-loaded plunger secured to the frame, wherein upon disengaging the locking mechanism, the one or more wheels roll onto the spring-loaded plunger, pushing the spring-loaded plunger downward to lock the swing arm dolly.

In some embodiments, the one or more wheels roll off of a platform of the frame and onto the spring-loaded plunger.

In some embodiments, the swing arm rotates counterclockwise about an axis at an end of the frame.

In some embodiments, the locking mechanism comprises an anti-back.

In some embodiments, the spring-loaded plunger locks the swing arm dolly by applying suction to prevent the swing arm dolly from moving.

According to various embodiments of the disclosed technology, a swing arm mechanism can comprise a platform locked to a frame by a locking mechanism, wherein the platform rotates about the frame upon disengaging the locking mechanism; two or more wheels supporting the platform; and a spring-loaded plunger secured to the frame, wherein upon disengaging the locking mechanism, the two or more wheels roll onto the spring-loaded plunger, pushing the spring-loaded plunger downward to secure the frame.

In some embodiments, the locking mechanism comprises an anti-back and a corresponding lever to release the anti-back.

In some embodiments, the two or more wheels supporting the platform roll onto the spring-loaded plunger when the platform rotates counterclockwise.

In some embodiments, pushing the platform back to its original position reengages the locking mechanism to secure the platform.

In some embodiments, the spring-loaded plunger secures the frame by applying suction to prevent the frame from moving.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates an example swing arm dolly in a locked position, in accordance with one embodiment.

FIG. 1B illustrates a perspective view of an example swing arm dolly in a locked position, in accordance with one embodiment.

FIG. 2 illustrates an example swing arm dolly in an open position, in accordance with one embodiment.

FIGS. 3A and 3B illustrate how the plunger locking mechanism is activated, in accordance with one embodiment.

The figures are not exhaustive and do not limit the present disclosure to the precise form disclosed.

### DETAILED DESCRIPTION

Mobile carts and dollies can be configured in various ways to transport an item(s). Traditional dollies can comprise a shelf on wheels so that users can roll the shelf to different locations. However, it can be difficult to reach a dolly if a user steps away from the dolly. An alternative is to continuously move the dolly as the user moves, but this can be tedious and delay an ongoing manufacture line. To provide a larger reach, some dollies incorporate a swing arm platform on the dolly. The swing arm platform can provide a flat surface that can rotate about an axis at an end of the dolly so that the swing arm reaches a point away from the rest of the dolly. This can allow a user to move further away from the dolly while still being able to reach items on the dolly.

Swing arms can be operated in various ways. Some swing arms incorporate a spring-loaded wheel mounted to a long arm. These swing arms may comprise pulleys and cables that are attached to a foot pedal for a user to kick. Kicking the foot pedal can open up the arm. However, these cables can break often, and tension can be inconsistent, causing the swing arm to only partially rotate to a desired point/location. Some swing arms can include a mechanical locking mechanism to hold the arm back. These mechanical locking mechanisms can also break after experiencing enough wear and tear resulting from repeated and frequent use.

Embodiments of the present disclosure provide a swing arm dolly with wheels under the swing arm that roll out on a platform to support the weight of the arm itself. These wheels can roll onto a spring-loaded plunger to lock the dolly in position. The arm when closed, can be held back by use of an anti-back on a lever. This lever can be lowered downward to disengage the locking mechanism and free the swing arm. This swing arm can improve ergonomics for a user as they move around the dolly. The user can reach for items on the dolly without a risk of tripping on cables or other tripping hazards like an overly long swing arm.

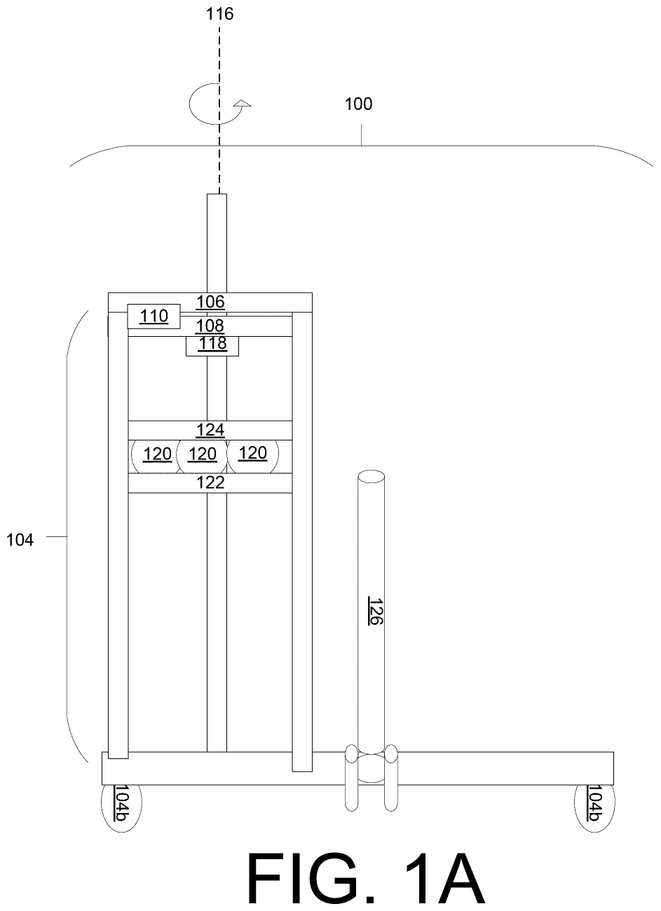

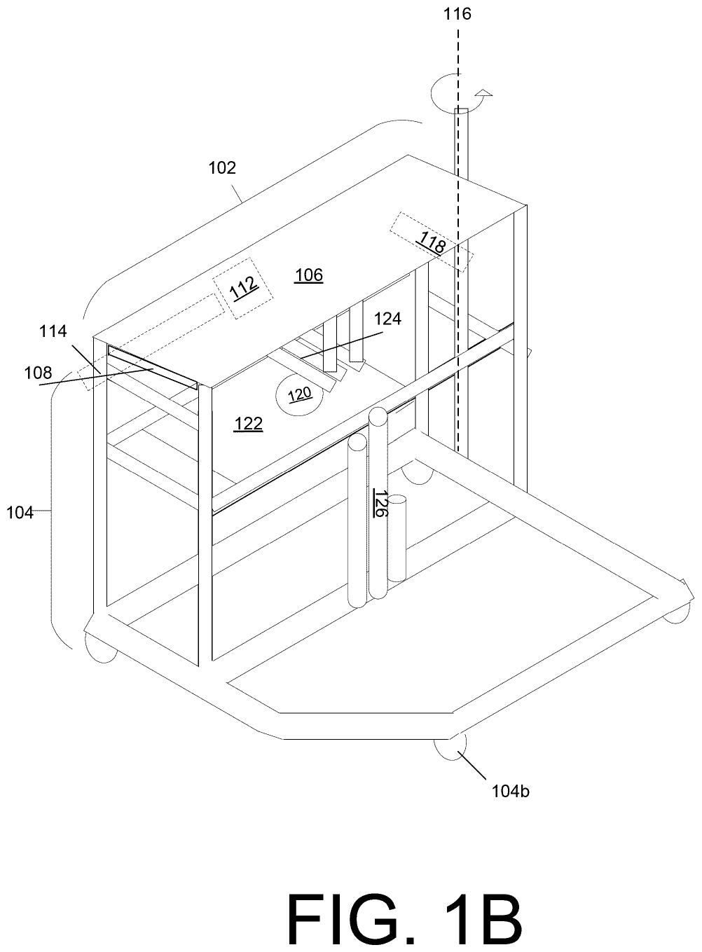

FIGS. 1A and 1B illustrate an example swing arm dolly 100 in a closed/locked position. The swing arm dolly 100 can be made of extruded aluminum and may be supported on track wheels that ride on a track on the floor. The swing arm dolly can comprise a swing arm portion 102 mounted on a dolly 104. Dolly 104 can include a frame 104a and wheels or coasters 104b to transport the dolly. In some embodiments, swing arm dolly 100 can move along a track to prevent extraneous movement. In the example of FIGS. 1A and 1B, swing arm portion 102 can comprise a swing arm connected to rectangular platform 106 that covers the top surface 108 of the frame 104a. Various items can be stored on platform 106 such as screw guns, screws, or other tools needed on an assembly line. Platform 106 can be configured with compartments or holders to store these various items and prevent them from moving when swing arm portion 102 rotates. Swing arm portion 102 can be held in place by locking mechanism 110. Locking mechanism 110 can comprise an anti-back stopper 112 on a spring-loaded lever 114 that can disengage by pushing the spring-loaded lever 114 downwards and away from locking mechanism 110. Applying an anti-back stopper can reduce the wear and tear to the locking mechanism 110 based on the motions required to disengage the locking mechanism. Alternatively, locking mechanism 110 can comprise any locking element to secure swing arm portion 102 to frame 104a. Upon disengaging locking mechanism 110, swing arm portion 102 can rotate about an axis 116 in a clockwise or counterclockwise direction. In the example of FIG. 1, swing arm portion 102 can rotate in a counterclockwise position. In some embodiments, swing arm portion 102 can be held open with a gas strut 118 once fully rotated. Gas strut 118 may be a 100N gas strut or any other gas strut that can hold swing arm portion 102 open to a certain degree depending on where the user is positioned in relation to swing arm dolly 100.

Wheels 120 can extend downward from the bottom of swing arm portion 102 onto a platform 122 secured to frame 104a. Wheels 120 can comprise one or more wheels. In one embodiment, wheels 120 can comprise two wheels extending from swing arm portion 102. Wheels 120 can be connected to a rod 124 that supports swing arm portion 102. As swing arm portion 102 rotates, wheels 120 can roll across the platform and off of the platform. Once off of the platform, wheels 120 can rotate onto plunger 126 and push the plunger downward into the ground. In some embodiments, plunger 126 can be a weighted plunger to provide additional force to secure the swing arm dolly. Plunger 126 can apply suction or force to the ground to prevent swing arm dolly 100 from moving. Plunger 126 can be secured to frame 104a to prevent swing arm portion 102 from rotating randomly due to the swing arm dolly moving across the track. The use of wheels and a plunger can make swing arm dolly 100 more compact than traditional dollies, which may incorporate long arms or separate mechanisms to secure the dolly. Furthermore, the movement of wheels 120 engages and disengages plunger 126 automatically, reducing the effort required to operate swing arm dolly 100. FIG. 1 illustrates plunger 126 in its original position, wherein the plunger is lifted off of the ground so that no suction is in place.

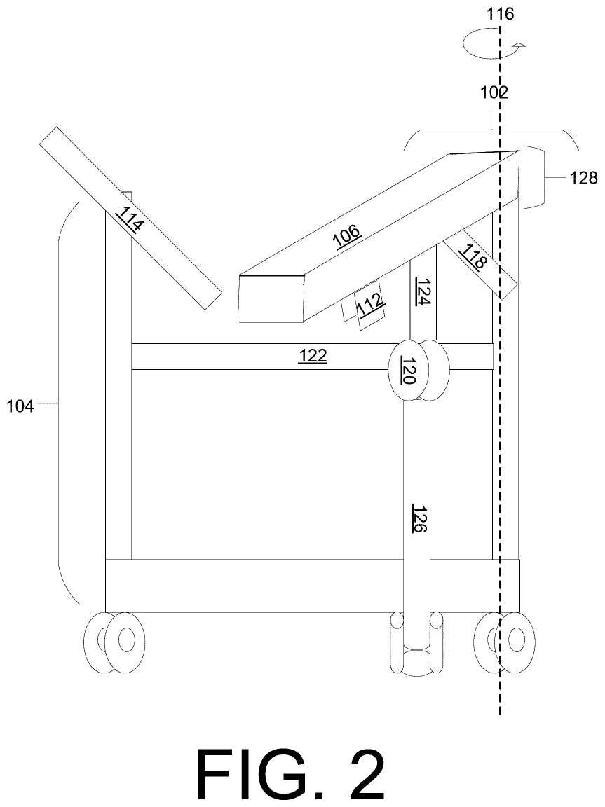

FIG. 2 illustrates the swing arm dolly as swing arm portion 102 rotates. As mentioned above, swing arm portion 102 can rotate counterclockwise after locking mechanism 110 is disengaged. In other embodiments swing arm portion 102 can rotate in a clockwise direction and may rotate to different degrees as needed depending on a user's desired position away from the dolly. Swing arm portion 102 can rotate about axis 116 by an end 128 of swing arm portion 102. Therefore, as a user steps away from the swing arm dolly, they can easily reach items on swing arm portion 102 because the arm is within reach of the user. To release swing arm portion 102, locking mechanism 110 can be disengaged when lever 114 is pushed downward, as illustrated in FIG. 2. To lock swing arm portion 102 back into place, swing arm portion 102 can be pushed back to its original position and lever 114 can be restored to a locked position with locking mechanism 110.

In operation, for example, a user, such as an automotive mechanic may typically rely on a conventional dolly on which he/she can store tools, for example, that he/she expects to use when repairing or constructing a vehicle. While a vehicle is constructed, it may traverse along a manufacturing line to achieve various construction goals at different points of the manufacturing line. Users working on the vehicle may typically stay within a range of motion to maintain position at the manufacturing line. Conventional dollies are free moving, so when user goes to use a dolly, he/she can grab the dolly and push or pull the dolly to the work area. A conventional dolly may not be within reach of the user's full range of motion while working on the vehicle. As a result, a conventional dolly would need to be moved or replaced in small incremental adjustments to position. These adjustments to position can be very inconvenient to the user and can significantly slow the manufacturing line when aggregated across multiple users encountering the same problem. Furthermore, to be close enough to the user, the dolly may be in the way of the user or other mechanics by blocking access to other portions of the vehicle or working area.

In contrast, swing arm dolly 100 provides a swing arm to which a platform is connected, giving more range of movement, more granular positioning, and quicker location adjustments. A user can move or position swing arm dolly 100 just as he/she would with conventional dolly. However, the user also has access to swing arm portion 102 of swing arm dolly 100 with its own set of wheels to allow for additional adjustment. Using swing arm dolly 100, the user can set the dolly in one position and access the items on the dolly while moving around the working area without having to readjust or move the dolly. Furthermore, the dolly can be further away from the vehicle, meaning that other mechanics would not be blocked from accessing other portions of the vehicle. Additionally, swing arm dolly 100 can be locked into one place to prevent free moving. This way, the user does not have to deal with a free moving dolly, nor does the user have to worry about constantly locking or unlocking the dolly to slightly adjust position. Swing arm dolly 100 allows a user to have even better access to tools and materials stored therein/thereon.

FIG. 2 illustrates plunger 126 as it is engaged. As described above, wheels 120 can roll off of platform 122 onto plunger 126. By rolling onto plunger 126, wheels 120 can push plunger 116 downward to apply suction to the ground. This force can prevent swing arm dolly 100 from moving. To disengage plunger 126, swing arm portion 102 can be pushed back to its original position so that wheels 120 are once again resting on platform 122. Removing wheels 120 can remove the force applied by plunger 126 to release the swing arm dolly. Once plunger 126 is disengaged, the swing arm dolly can be free to move across its track or other supporting surface.

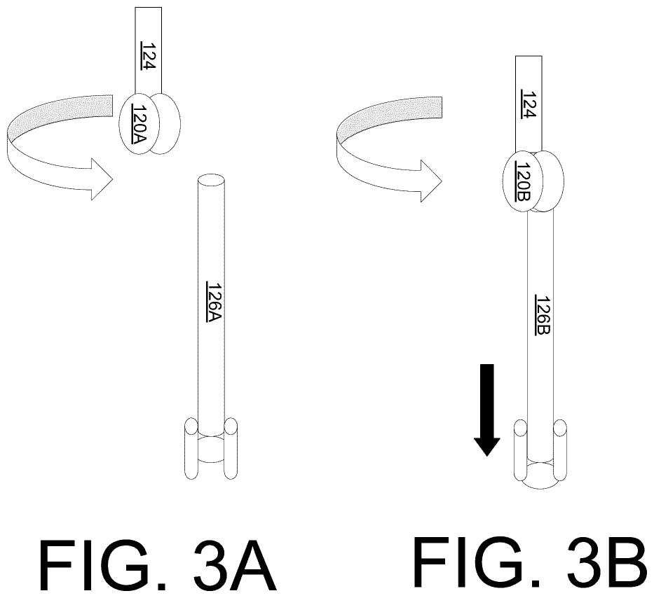

FIGS. 3A and 3B illustrate wheels 120 and plunger 126 as plunger 126 is engaged and disengaged. As described above, wheels 120A can rest on a platform when swing arm portion 102 is locked. When swing arm portion 102 rotates, wheels 120A can roll and rotate towards plunger 126A. In the example of FIGS. 3A and 3B, wheels 120A can rotate counterclockwise. Plunger 126A can be secured to frame 104a of swing arm dolly 100 in the path of wheels 120A. In a disengaged position, plunger 126A can be above the ground so that no force is applied. As illustrated in FIG. 3B, when wheels 120B roll onto plunger 126B, wheels 120B can push plunger 126B downward into the ground. Plunger 126B can comprise a plunger head at the end that presses into the ground and applies suction. This force can prevent the swing arm dolly from moving. Swing arm portion 102 can stop rotating when wheels 120B are resting on plunger 126B. As described above, swing arm portion 102 can be held open in this position by gas strut 118. As swing arm portion 102 is held open, plunger 126B can remain engaged. When swing arm portion 102 is pushed back and locked into place, plunger 126B can lift off of the ground to remove force.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A swing arm dolly comprising:
a swing arm mounted on a frame;
a lever and locking mechanism locking the swing arm to the frame;
one or more wheels extending downward from the swing arm; and
a spring-loaded plunger secured to the frame, wherein upon disengaging the locking mechanism, the one or more wheels roll onto the spring-loaded plunger, pushing the spring-loaded plunger downward to lock the swing arm dolly.

2. The swing arm dolly of claim 1, wherein the one or more wheels roll off of a platform of the frame and onto the spring-loaded plunger.

3. The swing arm dolly of claim 1, wherein the swing arm rotates counterclockwise about an axis at an end of the frame.

4. The swing arm dolly of claim 1, wherein the locking mechanism comprises an anti-back.

5. The swing arm dolly of claim 1, wherein the spring-loaded plunger locks the swing arm dolly by applying suction to prevent the swing arm dolly from moving.

6. A swing arm mechanism comprising:
a platform locked to a frame by a locking mechanism, wherein the platform rotates about the frame upon disengaging the locking mechanism;
two or more wheels supporting the platform; and
a spring-loaded plunger secured to the frame, wherein upon disengaging the locking mechanism, the two or more wheels roll onto the spring-loaded plunger, pushing the spring-loaded plunger downward to secure the frame.

7. The swing arm mechanism of claim 6, wherein the locking mechanism comprises an anti-back and a corresponding lever to release the anti-back.

8. The swing arm mechanism of claim 6, wherein the two or more wheels supporting the platform roll onto the spring-loaded plunger when the platform rotates counterclockwise.

9. The swing arm mechanism of claim 6, wherein pushing the platform back to its original position reengages the locking mechanism to secure the platform.

10. The swing arm mechanism of claim 6, wherein the spring-loaded plunger secures the frame by applying suction to prevent the frame from moving.
